(19) United States
(12) Patent Application Publication
(10) Pub. No.: US 2008/0050594 A1
(43) Pub. Date: Feb. 28, 2008

(54) Electrically Conductive Pigments Having a Ferromagnetic Core, the Production Thereof, and the Use Thereof

(75) Inventors: Thomas Schuster, Lauf (DE); Harald Weiss, Furth (DE)

Correspondence Address: OSTROLENK FABER GERB & SOFFEN, 1180 AVENUE OF THE AMERICAS, NEW YORK, NY, 100368403, US

(73) Assignee: ECKART GMBH & CO. KG, Furth (DE)

(21) Appl. No.: 11/574,002

(22) PCT Filed: Aug. 11, 2005
(86) PCT No.: PCT/EP05/08710

§ 371 Date: Jun. 6, 2007

(30) Foreign Application Priority Data
Aug. 19, 2004 (DE) 10 2004 040 444.5

(51) Int. Cl. B05D 7/00; B32B 5/16

(52) U.S. Cl. 428/407; 427/222

(57) ABSTRACT

The invention relates to electrically conductive pigments, wherein the pigments exhibit a ferromagnetic core and at least one electrically conductive coating, and the electrically conductive coating is or comprises a metal or a metal alloy or the electrically conductive coating is or comprises electrically conductive polymers or plastics materials containing electrically conductive polymers. The invention further relates to a process for the production of said electrically conductive pigments, and to the use of said electrically conductive pigments.

The invention relates to electrically conductive pigments, to the production thereof, and to the use thereof.

Iron pigments are generally used for decorative purposes but may also be used as functional pigments. Uses having predominantly optical effects are, for example, paints and enamel coatings, colorants for plastics, printing inks, and coloring agents for glass and ceramics.

Platelet-type iron pigments are commonly produced by crushing or grinding atomized iron grit with the addition of lubricants. Such processes are described in detail in EP 673 980. In this way, in particular, relatively coarse particles having a broad particle size distribution are obtained.

Another process for the production of platelet-type iron pigments is vacuum vapor deposition using PVD procedures, preferably by electron beam, in which a thin film of iron is deposited on the support material, which can then be comminuted into pigments. In this way particles having a uniform thickness and high reflectivity are obtained.

Production of iron pigments from carbonyl iron powder that has undergone a reducing treatment is described in DE 101 14 446 A1. During the grinding, which may be done either wet or dry, substantially only the initial material is deformed into platelets and not comminuted. To prevent cold welding of the iron particles during grinding a lubricant must be added, e.g., a fatty acid such as stearic acid or oleic acid. The object of the invention described in DE 101 14 446 A1 is to provide iron pigments that can be used in optically highly demanding coatings.

The object of the present invention is to find electrically conductive pigments that permit new application possibilities. Another object of the invention is to provide pigments that have demonstrable magnetic and/or electric properties after they have been applied to, or introduced into, an object.

The inventors have now discovered, surprisingly, that further application possibilities arise as a result of the preparation of electrically conductive pigments as defined in claim 1, which have a ferromagnetic core and at least one electrically conductive coating.

Preferred developments of the electrically conductive pigments are defined in the subordinate claims 2 to 10.

According to a preferred development of the invention, the ferromagnetic core of the pigments according to the invention is present in platelet form. The platelet-type pigments of the invention preferably have sizes ranging from 2 to 500 μm, preferably from 5 to 200 μm, and more preferably from 10 to 50 μm.

According to another preferred embodiment, the ferromagnetic core of the pigments according to the invention is present in spherical form.

Usually, platelet-type pigments are obtained after application of the electrically conductive coating to a platelet-type ferromagnetic core. Ordinarily, spherical pigments are obtained following the application of the electrically conductive coating to a spherical ferromagnetic core.

The ferromagnetic core preferably contains, or consists of, one or more metals or metal compounds selected from the group consisting of iron, cobalt, nickel, gadolinium, alloys containing these elements, δ-FeOOH, EuS, CrO₂ Cu₂MnAl, and mixtures thereof. The alloys of the Cu₂MnAl type are also designated as Heusler alloys.

The ferromagnetic core preferably consists of, or contains, iron.

The ferromagnetic core of iron is more preferably produced by wet grinding carbonyl iron grit and preferably has a thickness of less than 150 nm. For example, one such pigment is produced according to DE 101 14 446 A1, which is incorporated herein by reference.

The electrically conductive material comprises, or is, a metal alloy. The metal or metal alloy is preferably selected from the group consisting of rhodium, nickel, silver, mixtures thereof, and alloys that contain these metals.

Alternatively, electrically conductive polymers or plastics materials containing such electrically conductive polymers may be used as electrically conductive material.

The electrically conductive polymers are preferably selected from the group consisting of polypyrrole, polythiophene, polyphenylene, polyaniline, polyacetylene, and mixtures thereof.

The thickness of the electrically conductive coating is preferably from 5 to 200 nm and more preferably from 10 to 100 nm.

The pigments of the invention having a conductive coating, preferably iron pigments of carbonyl iron, preferably display a total thickness of from 80 to 550 nm, more preferably from 100 to 350 nm, and most preferably from 120 to 250 nm. The advantage of these pigments is that they are particularly thin pigments that become oriented very well in an electric or magnetic field.

Pigments are also produced according to the invention that are not only electrically conductive but also have ferromagnetic properties.

Electrically conductive pigments, preferably iron pigments, may be used—especially with regard to their ferromagnetic properties—for the production of security elements. The electrically conductive pigments according to the present invention thus display certain electrical and/or magnetic properties that are demonstrable.

The aforementioned security elements are normally designed as flat elements that are positioned flatly on the documents or articles to be secured. The pigments of the invention may naturally also be part of an article to be secured, i.e. they may be incorporated in a plastics material, for example. In such cases only a one-time orientation of the pigments of the invention by application of an electrical or magnetic field is possible before the surrounding medium is cured. The article then displays well-defined or demonstrable magnetic and/or electrical properties as a result of the orientation of the electrically conductive pigments of the invention.

The security elements are preferably used in so-called intelligent switches. Intelligent switches are characterized, for instance, in that the ferromagnetic iron pigments in a coating or in an article can be oriented in a desired direction by application of a magnetic field and/or electrical field. By applying an electrical and/or magnetic field, the electrical conductivity and/or the optical properties of the coating or article can be altered substantially reversibly, preferably fully reversibly. The application medium used is a viscous medium that, on the one hand, allows the pigments sufficient mobility for reorientation but, on the other hand, possesses sufficient restoring force for moving the pigments back to their original position.

This means that by application of a preassigned electrical and/or magnetic field to a coating containing the electrically conductive iron pigments of the invention certain electrical and/or optical effects can be obtained. Then, when the preassigned electrical and/or magnetic field is applied and the anticipated electrical and/or optical effects are not obtained, this is an indication that the secured article is counterfeit.

Within the scope of the invention, the security elements such as, for example, holograms are preferably used for identification of the genuineness of security documents such as bank notes, passports, ID cards, check cards, credit cards, securities, and secured articles such as drugs, data storage media, etc.

The electrically conductive pigments of the present invention, preferably having an iron pigment core, may also be used as a coating on, or intermediate layer of, transparent support materials, such as disks of glass or plastics materials. Depending on the electrical field applied, it is possible to adjust or alter the transparency or the optical transparency, respectively, of the inherently transparent support material. For example, the disks of glass or plastics material can be made impermeable to visible light, UV radiation, and/or IR radiation.

It is thus possible to apply the electrically conductive pigments of the invention, preferably those having an iron pigment core, as a protective coating to disks of glass or plastics material to cause them—after application of an electric field—to reflect incident sunlight and thereby prevent a building from heating up. The coating may—after application of an electrical field—also serve to reduce the transparency for visible light so that, say, the interior of a glazed room is no longer visible to the eyes of a third party.

The electrically conductive pigments of the invention may also be used for electromagnetic shielding. For example, a housing of an electrical or electronic device may be provided with a coating containing the electrically conductive pigments of the invention. The electrically conductive pigments may also be incorporated in plastics materials, from which then, say, plastic housings can be fabricated that reliably shield against electromagnetic radiation.

Reliable shielding from electromagnetic radiation is thus possible due to the electromagnetic properties of the electrically conductive pigments of the invention.

The conductive pigments of the invention may therefore find use in conductive coatings, conductive articles, coatings or articles with electromagnetic-radiation-shielding properties, as well as in switches or intelligent switches.

The basic object of the invention is also achieved by the provision of a pigment mixture which comprises a mixture of platelet-type, electrically conductive pigments and spherical, electrically conductive pigments according to the present invention.

It has been shown, surprisingly, that when the pigment mixture of the invention is applied, for example in the form of a coating, to an article or when it is introduced into an article, the electrical conductivity thereof can be improved. The improved conductivity is in this case traceable to the enhanced contact probability and the enhanced number of points of contact provided by spherical and platelet-type pigments in the pigment mixture.

The underlying object of the invention is additionally achieved by a process for the production of electrically conductive pigments as defined in claim 11, in which a coating of at least one electrically conductive material is applied to a ferromagnetic starting pigment.

Preferred developments of the process of the invention are defined in subordinate claims 12 to 14.

For applications in the sector of electromagnetic shielding or so-called “intelligent switches”, the pigments obtained by a grinding process, preferably iron pigments, usually cannot be used as such, since the lubricant layer on the pigments, preferably iron pigments, adheres to them unusually strongly.

If the starting pigment has a layer of lubricant, it must be degreased before it is coated with conductive material.

Especially in the case of the preferably used iron pigments that are conventionally produced by grinding, for example in a ball mill with the addition of lubricants, the iron pigment surface is covered with an unwanted firmly adhering layer of lubricant. The lubricant layer ordinarily consists of stearic acid or oleic acid and their iron salts and degradation products. The iron pigments also usually have an oxide layer on the iron pigment surface. The lubricant layer and oxide layer have the effect that no electrically conducting contact exists between adjacent iron pigment particles.

In order to make the pigments produced by grinding, especially the iron pigments, electrically conductive, the pigments, preferably iron pigments, are provided, in accordance with the present invention, with an electrically conductive coating.

However, it has been found that it is impossible or nearly impossible to remove noteworthy quantities of the lubricant from the pigments, preferably iron pigments, by conventional methods. A well-known process in which aluminum pigments are moved in an oxygen-containing gas and optionally additionally treated with steam in order to substantially remove the lubricant layer is described, for example, in EP 580 222 B1. The process disclosed in EP 580 022 is also suitable for degreasing iron pigments.

Preferably, however, the initial pigments, preferably iron pigments, are degreased by treating them with concentrated NaOH in an organic solvent. The degreasing solution used is preferably a concentrated alcoholic NaOH solution such as, for example, an approximately 10% strength NaOH solution in ethanol, by weight.

The inventors have now discovered, surprisingly, that electrically conductive pigments having ferromagnetic properties can be produced by providing ferromagnetic pigments, preferably degreased pigments, more preferably degreased iron pigments, with an electrically conductive coating.

All ferromagnetic pigments are suitable starting materials, preferably iron pigments produced by one of the known production processes.

Iron pigments of carbonyl iron are preferably used, since they display better orientation behavior in a coating or in, or on, an article because of their reduced thickness compared with conventional iron pigments.

When iron pigments are used as the starting pigments, the latter are preferably obtained by grinding iron powder, preferably carbonyl iron powder.

Iron pigments are exceptionally well suited for use as starting pigments for the production of the electrically conductive pigments of the invention, because iron pigments can be produced relatively economically and display good application-engineering properties.

An essential feature of the pigments of the invention is the fact that the ferromagnetic properties of the core are preserved despite the coating with an electrically conductive material.

In principle, pigments, preferably iron pigments, produced by PVD processes may also be used. However, PVD pigments are very expensive due to the high cost of their production so that they are only in exceptional cases suitable for use as electrically conductive pigments having ferromagnetic properties.

The conductive material can, for example, be applied to the starting pigment from a suitable precursor, e.g., a metal carbonyl, in a fluidized bed process.

The conductive metallic material M can also be applied in a chemical wet process by currentless deposition according to formula (I)
Fe+M^{z+}+Red→Fe/M+Ox (I)
and/or—if M is nobler than iron—according to formula (II)
Fe+M^{z+→Fe/M+Fe}^{2/3+} (II)
to the preferably used iron starting pigment, wherein “Red” stands for a reducing agent that is transformed into an oxidized form “Ox”.

The reducing agent or agents used may, for example, be one or more substances selected from the group consisting of hydrazine, aldehydes, methanol, ethanol, sugar, hypophosphite, and/or formaldehyde.

In one possible embodiment, first the nobler metal can be deposited without the presence of a reducing agent and subsequently reduction can be carried out in the presence of a reducing agent. This may be necessary due to the fact that during currentless deposition according to formula (II) the reaction may come to a stop as soon as the coating has reached a thickness and density above which the iron is no longer available as a reaction partner. In order nevertheless to obtain the desired layer thickness, an additional deposition is possible by reducing a metal compound by means of a reducing agent according to formula (I).

Preferably, additional additives acting as luster formers are added to the currentless chemical wet deposition of the metal. Lactic acid may be used in this case, for example.

The fundamental object of the invention is also achieved by the use of the electrically conductive pigments or pigment mixture of the invention in electrically conductive coatings and/or electrically conductive articles.

The electrically conductive pigments or pigment mixture according to the invention are preferably used in coatings or articles for shielding from electromagnetic radiation.

The present invention also relates to the use of the electrically conductive pigments or pigment mixture of the invention in intelligent switches or coatings in which the electrically conductive pigments can be oriented in a desired direction by applying a magnetic field and/or an electrical field.

The object of the invention is also achieved by an article that contains and/or consists of the electrically conductive pigments or pigment mixture of the invention. The article is preferably a security element, security document, security object, or transparent material.

The examples presented below are intended to illustrate the invention without limiting it thereto.

### EXAMPLE

100 g of iron pigment (VP 58031/G) are stirred in 500 g of 10% w/w strength ethanolic NaOH solution for one hour at 50° C. The product is then suction filtered, washed a number of times with ethanol and dried in hot air.

100 g of the thus degreased iron pigment are suspended in 300 g of deionized water. Then a solution of 200 g of NiSO₄.7H₂O, 30 g of lactic acid, and 5 g of hydrazine sulfate in 2 l of deionized water are added, and the mixture is heated to 60° C. Then a solution of 150 g of sodium hypophosphite in 500 ml of deionized water is added. The pH is adjusted to a constant 5.4 by regulated addition of a 1 M NaOH solution. After stirring for 2 hours, the reaction batch is suction-filtered and the filter cake washed a number of times with ethanol. Then it is dried overnight in a vacuum drying cabinet.

2.5 g of pigment were thoroughly predispersed in 2.5 g of a 1:1 w/w mixture of ethyl acetate and ethanol and mixed with 2.5 g of a 40% strength solution of neocryl B 725 in a 1:1 v/v mixture of butyl acetate and isopropanol and stirred a number of times. The material was applied to a Hostaphan foil using a 100 μm scraper blade. Following a flashtime of 5 min, the foil was dried for 30 min at 60° C. The resistance was measured by two-point measurement at three different places on the sample. The average value was 1.1×10⁻³ Ω.

1. Electrically conductive pigments,
characterized in that
the pigments exhibit a ferromagnetic core and at least one electrically conductive coating, wherein the electrically conductive coating is or comprises a metal or a metal alloy or wherein the electrically conductive coating is or comprises electrically conductive polymers or plastics materials containing electrically conductive polymers.

2. Electrically conductive pigments as defined in claim 1, wherein the ferromagnetic core is in the form of a platelet or is spherical.

3. Electrically conductive pigments as defined in claim 1, wherein
the ferromagnetic core contains or consists of one or more metals or metal complexes, selected from the group consisting of iron, cobalt, nickel, gadolinium, alloys containing the aforementioned metals, d-FeOOH, EuS, CrO₂, Cu₂MnAl, and mixtures thereof.

4. Electrically conductive pigments as defined in claim 1 wherein
said ferromagnetic core consists of or contains iron.

5. Electrically conductive pigments as defined in claim 1,
wherein
the ferromagnetic core of iron is produced from carbonyl iron grit by wet milling and preferably has a thickness of less than 150 nm.

6. Electrically conductive pigments as defined in claim 1, wherein
the metal is selected from the group consisting of rhodium, nickel, silver, and mixtures and alloys thereof which contain these metals.

7. Electrically conductive pigments as defined in claim 1, wherein
the electrically conductive polymers are selected from the group consisting of polypyrrole, polythiophene, polyphenylene, polyaniline, polyacetylene, and mixtures thereof.

8. Electrically conductive pigments as defined in claim 1, wherein
the thickness of the coating is from 5 to 200 nm and preferably from 10 to 100 nm.

9. Electrically conductive pigments as defined in claim 1, wherein
the size of the pigments is from 2 to 500 μm and preferably from 5 to 200 μm.

10. Electrically conductive pigments as defined in claim 1, wherein
the overall thickness of the coated pigments is from 80 to 550 nm and preferably from 100 nm to 350 nm.

11. A process for the production of electrically conductive pigments,
wherein
at least one coating of at least one electrically conductive material is applied to a ferromagnetic starting pigment, wherein said electrically conductive material is or comprises a metal or a metal alloy or wherein said electrically conductive material is or contains electrically conductive polymers or plastics materials which contain electrically conductive polymers.

12. A process for the production of electrically conductive pigments as defined in claim 11,
wherein
the ferromagnetic starting pigment contains or consists of one or more metals or metal complexes, which are selected from the group consisting of iron, cobalt, nickel, gadolinium, alloys containing the aforementioned metals, d-FeOOH, EuS, CrO₂, Cu₂MnAl, and mixtures thereof.

13. The process as defined in claim 11,
wherein
the starting pigments are iron pigments.

14. The process as defined in claim 13,
wherein
the iron pigments are obtained by grinding carbonyl iron powder.

15. The process as defined in claim 13,
wherein
the iron pigments are obtained by PVD deposition of an iron film onto a flat support material followed by comminution of the iron film.

16. The process as defined in any one of claims 13,
wherein
the iron pigments are degreased prior to the application of the electrically conductive coating.

17. The process as defined in claim 16,
wherein
the degreasing is carried out by treating the iron pigments with sodium hydroxide in an organic solvent, preferably ethanol.

18. The process as defined in claim 11,
wherein
the electrically conductive material is applied by a chemical wet-process by currentless deposition with or without a reducing agent.

19. The process as defined in claim 11,
wherein
the conductive material is applied to the iron pigments from the vapor phase in a fluidized-bed process.

20. The process as defined in claim 11,
wherein
the conductive material is first applied by currentless deposition in the absence of a reducing agent followed by reduction with a reducing agent.

21. The process as defined in claim 18,
wherein
the reducing agent is selected from the group consisting of hydrazine, aldehydes, methanol, ethanol, sugar, phosphinate, formaldehyde, and mixtures thereof.

22. The process as defined in claim 11,
wherein
the metal or the metal alloy is selected from the group consisting of rhodium, nickel, silver, mixtures, and alloys thereof.

23. The process as defined in claim 11,
wherein
the electrically conductive polymers are selected from the group consisting of polypyrrole, polythiophene, polyphenylene, polyaniline, polyacetylene, and mixtures thereof.

24. The process as defined in claim 11,
wherein
the electrically conductive pigments are spherical and/or in the form of platelets.

25. A pigment mixture,
wherein
the pigment mixture comprises a mixture of platelet-type and spherical electrically conductive pigments as defined in claim 1.

26. The use of electrically conductive pigments as defined in claim 1 in electrically conductive coatings and/or electrically conductive objects.

27. The use of electrically conductive pigments as defined in claim 1 in coatings or objects to effect shielding from electromagnetic radiation.

28. The use of electrically conductive pigments as defined in claim 1 in intelligent switches or coatings, in which, by application of a magnetic field and/or an electric field, the electrically conductive pigments can be oriented in a desired direction

29. An object,
characterized in that
the object contains and/or comprises electrically conductive pigments as defined in claim 1

30. An object as defined in claim 29,
wherein
the object is a security element, security document, security object, or transparent material.

31. The use of a pigment mixture as defined in claim 25 in electrically conductive coatings and/or electrically conductive objects.

32. The use of a pigment mixture as defined in claim 25 in coatings or objects to effect shielding from electromagnetic radiation.

33. The use a pigment mixture as defined in claim 25 in intelligent switches or coatings, in which, by application of a magnetic field and/or an electric field, the electrically conductive pigments can be oriented in a desired direction

34. An object,
wherein
the object contains and/or comprises electrically conductive pigments as defined in a pigment mixture as defined in claim 25.
